(19) United States
(12) Patent Application Publication
(10) Pub. No.: US 2004/0100876 A1
(43) Pub. Date: May 27, 2004

(54) Method for accessing data on an optical disc

(76) Inventors: Kuo-Hsuan Luo, Taipei Hsien (TW); Kun-Huei Chen, Taipei Hsien (TW)

Correspondence Address: NAIPO (NORTH AMERICA INTERNATIONAL PATENT OFFICE), P.O. BOX 506, MERRIFIELD, VA, 22116, US

(21) Appl. No.: 10/065,904

(22) Filed: Nov. 27, 2002

(51) Int. Cl. G11B 7/085

(52) U.S. Cl. 369/30.07

(57) ABSTRACT

A method for accessing an optical disk with an optical disc drive. The optical disc contains at least a session including a lead-in area and a program data area. The method for accessing the optical disk with the optical disc drive includes providing the optical disc drive an optical pickup for accessing the data on the optical disc, using the optical pickup to record a table of contents (TOC) in the lead-in area of the session of the optical disc, using the pick-up head to record descriptive data corresponding to the TOC in the lead-in area of the session, and using the optical pickup to record program data corresponding to the TOC in the program data area of the session.

### BACKGROUND OF INVENTION

1. Field of the Invention

The invention relates to a method for accessing data on an optical disc with an optical disc drive, and more particularly, to a method for recording a table of contents and descriptive data corresponding to the table of contents to the optical disc with the optical disc drive.

2. Description of the Prior Art

With the constant development of computer technology, most information is transformed into digital data so that users can transmit information or record information more easily. Meanwhile, to help users record the digital data more conveniently, there are a variety of devices for recording the digital data. Take an optical disc drive and an optical disc for example. The optical drive uses the optical disc with the advantages of low-price, small size, and large capacity for recording the digital data so as to let the users conveniently record the digital data.

Please refer to FIG. 1. FIG. 1 is a diagram of accessing data on an optical disc 20 with an optical disc drive 10 according to the prior art. The optical disc 20 comprises a spiral track 22 extending outward from a center to an outer edge of the optical disc 20, and the spiral track 22 is covered with a photo-resist layer 24 (which is not shown in FIG. 1). The optical disc drive 10 comprises an optical pickup 12 used to emit a laser according to whether the data is “0” or “1”, and records the data to the optical disc 20 with the optical disc drive 10. Therefore, the photo-resist layer 24 on the spiral track 22 of the optical disc 20 is intermittently exposed to the laser, thus, the photo-resist layer 24 is left with pits in areas that were exposed to the laser, and lands remain in the areas not exposed to the laser. According to the difference between the rates of the laser reflected from a pit and a land, the pit and the land on the optical disc 20 each can represent content of data, for example, a digital “0” and a digital “1”. On the other hand, the optical disc drive 10 also uses the optical pickup 12 to receive the reflected laser so as to read data on the optical disc 20 by analyzing the data based on the different rates of the reflected laser.

According to the rules of the Orange Book, the spiral track 22 of the optical disc 20 can be divided into at least one session comprising a lead-in area, a program data area, and a lead-out area. As shown in FIG. 1, the optical disc 20 comprises at least one session 26 comprising a lead-in area 28, a program data area 30, and a lead-out area 32. The program data area 30 is used to record one or a plurality of tracks, which is used to record data or audio. Generally speaking, if the session 26 is used to record data, the session 26 can only contain a track, so that the optical disc 20 can contain a plurality of tracks, and if the session 26 is totally used to record audio, the session 26 can contain a plurality of tracks, so that the optical disc 20 can still contain a plurality of tracks. The lead-in area 28 of the session 26 comprises data of amount of tracks, the beginning position of the tracks, and the length of the tracks in the program area 30 of the session 26. These three kinds of data are generally called a table of contents (TOC). The optical disc drive 10 controls and moves the optical pickup 12 to a specific position of the optical disc 20 according to the data of the TOC so as to read data on the specific position. Because the lead-out area 32 of the session 26 is recorded with data of digital silence, the optical disc drive 10 can determine that the optical pickup 12 has read all the data on the program area 30 of the session 26 when the optical pickup 12 has read the data of digital silence on the lead-out area 32.

The lead-in area of each session of the optical disc 20 comprises 4500 sectors, and the length of each sector is 2 K bytes, so the length of the lead-in area of each session of the optical disc 20 is 9 M bytes (2 k bytes×4500=9 M bytes). According to the prior art, because the sectors of each lead-in area of the optical disc pickup 20 are only used for recording the TOC, the rest of the memory space in the sectors is wasted. Furthermore, if the optical disc 20 comprises a plurality of sessions, there will be plenty of memory space of the sectors wasted.

### SUMMARY OF INVENTION

It is therefore a primary objective of the claimed invention to provide a method for accessing data on an optical disc with an optical disc drive to solve the above-mentioned problem.

According to the claimed invention, the optical disc drive is used to access the data on the optical disc that comprises at least one session. Each session comprises a lead-in area and a program data area. The claimed method comprises providing the optical disc drive with an optical pickup for accessing the data on the optical disc, using the optical pickup to record a table of contents in the lead-in area of the session of the optical disc, using the optical pickup to record descriptive data corresponding to the table of contents in the lead-in area of the session, and using the optical pickup to record program data corresponding to the table of contents in the program data area of the session.

The method further comprises using the optical pickup to read the table of contents and the descriptive data on the lead-in area of the session, providing the optical disc drive with a monitor, using the optical pickup to read the program data on the program data area of the session according to the table of contents on the lead-in area of the session, and using the optical drive to execute the program data and display the descriptive data on the monitor at the same time.

It is an advantage of the claimed invention that the method for accessing the data on the optical disc with the optical disc drive can use the rest of the memory space in the lead-in area of the optical disc for recording the descriptive data describing the program data on the program data area of the optical disc so that the memory space of the lead-in area can be fully utilized.

These and other objectives of the present invention will no doubt obvious to those of ordinary skill in the art after reading the following detailed description of the preferred embodiment that is illustrated in the various figures and drawings.

### BRIEF DESCRIPTION OF DRAWINGS

FIG. 1 is a diagram of accessing data on an optical disc with an optical disc drive according to the prior art.

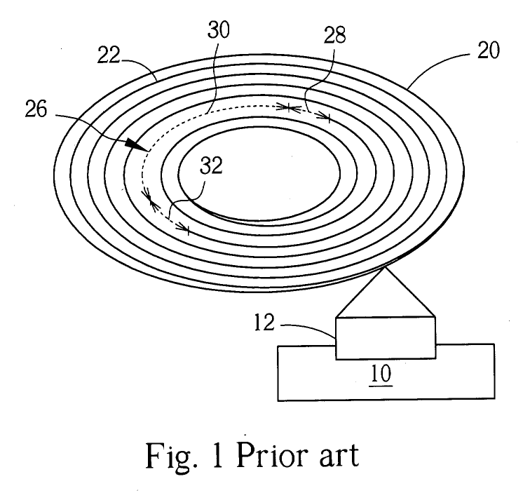

FIG. 2 is a diagram of accessing data on an optical disc with an optical disc drive according to a present invention.

FIG. 3 is a diagram of descriptive data recorded in a lead-in area of a session of the optical disc according to another embodiment of the present invention.

FIG. 4 is a flow chart of a method for accessing data on the optical disc with the optical disc drive according to the present invention.

### DETAILED DESCRIPTION

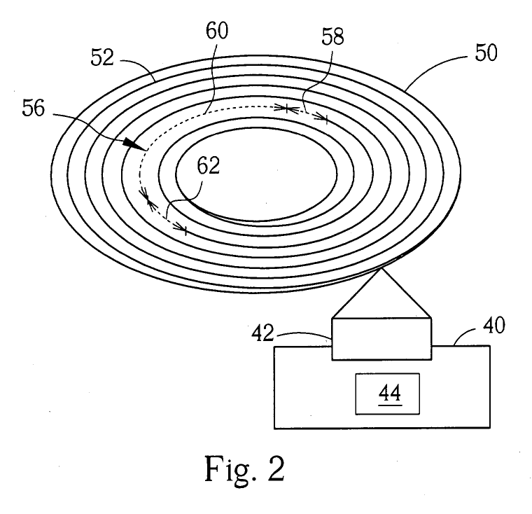

Please refer to FIG. 2. FIG. 2 is a diagram of accessing data on an optical disc 50 with an optical disc drive 40 according to a present invention. As with the optical disc 20 of the prior art, the optical disc 50 also comprises a spiral track 52, and the spiral track is also covered with a photo-resist layer 54 (which is not shown in FIG. 2). The optical disc drive 40 comprises an optical pickup 42 which is used to emit laser and expose the photo-resist layer 54 on the spiral track 52 of the optical disc 50 to the laser so as to record data to the optical disc 50. However, the optical disc drive 40 of the present invention further comprises a monitor 44. The optical disc 50 of the present invention can be a CD-ROM, a VCD, or a DVD. The optical disc drive 40 can be a CD-ROM drive, a VCD drive, or a DVD drive.

The optical disc 50 comprises at least one session 56, so if the optical disc 50 comprises a plurality of sessions, the plurality of sessions are arranged in outward order starting from the center of the optical disc 50. Each session 56 comprises a lead-in area 58, a program data area 60, and a lead-out area 62. The lead-in area 58 of the session 56 comprises a table of contents comprising the data of the amount of tracks, the beginning position of the tracks, and the length of the program data in the program area 60 of the session 56. The optical disc drive 40 controls and moves the optical pickup 42 to a specific position of the optical disc 50 according to the data of the table of contents so as to read the data on the specific position. Because the lead-out area 62 of the session 56 is recorded with data of digital silence, the optical disc drive 40 can determine that the optical pickup 42 has read all the program data on the program area 60 of the session 56 when the optical pickup 42 has read the data of digital silence on the lead-out area 62.

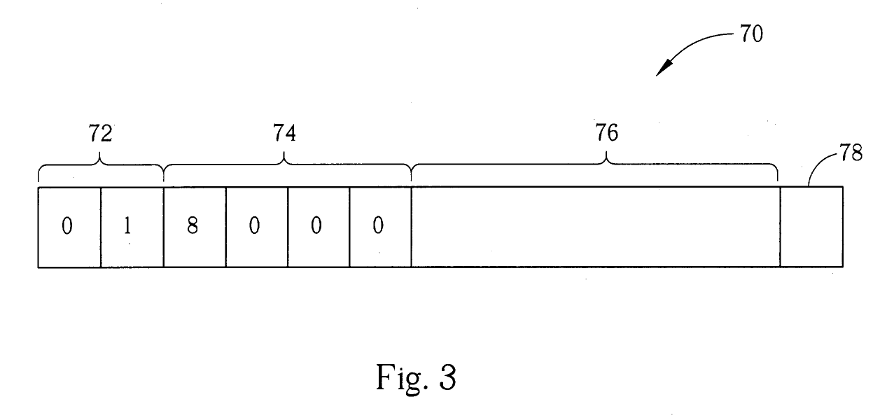

The difference between the optical disc 50 of the present invention and the optical disc 20 of the prior art is that the lead-in area 58 of the optical disc 50 not only comprises the table of contents, but also comprises descriptive data 70 (which is shown in FIG. 3) used to describe the program data recorded on the program data area 60 of the optical disc 50. In addition, the method of the present invention uses the rest of the memory space of the lead-in area 58 that is not recorded with the table of contents to record the descriptive data 70 so as to fully utilize the memory space of the lead-in area 58 of the optical disc 50. For instance, if the table of contents occupies 5 M bytes of the memory space, the descriptive data 70 is recorded with the remaining 4 M bytes of the memory space. More specifically, the descriptive data 70 comprises a content data for describing the program data on the program data area 60. For instance, if the program data recorded on the program data area 60 of the session 56 of the optical disc 50 is a song, the descriptive data recorded on the lead-in area 58 of the session 56 can be data of words of the song, composer of the song, or other information for describing the song.

Please refer to FIG. 3. FIG. 3 is a diagram of the descriptive data 70 recorded in the lead-in area 58 of the session 56 of the optical disc 50 according to another embodiment of the present invention. The descriptive data 70 comprises four kinds of data including a category data 72, a length data 74, a content data 76, and an ending data 78, in order. The category data 72 is used for marking a category of the content data 76, and the length data is used for marking a length of the content data 76. Take the descriptive data 70 shown in FIG. 3 for example. The category data 72 is “01”, which represents that the content data 76 recorded on the lead-in area 58 are words of the program data that is assumed to be a song recorded on the program data area 60. The length data 74 is “8000”, which represents that the length of the words of the song is 8000 bytes. The ending data 78 of the descriptive data 70 is used for marking an ending position of the descriptive data 70. Thus, the optical disc drive 40 can determine that the optical pickup has read all the data of the descriptive data 70, when the optical pickup 42 of the optical disc drive 40 has read the ending data 78 of the descriptive data 70 on the lead-in area 58 of the session 56 of the optical disc 50.

When the optical pickup 42 of the optical disc drive 40 has read all the data including the table of contents and the content data 70 on the lead-in area 58 of the session 56 of the optical disc 50, it will continually read the program data on the program data area 60 of the session 56 of the optical disc 50. When the optical pickup 42 of the optical disc drive 40 is used to read the program data and the optical disc drive 40 executes the program data, the optical disc drive 40 displays the content data 76, which is read by the optical pickup 42 previously and describes the program data, on the monitor 44.

When the category data 72 is “00”, “10”, or “1”, this represents that the content data 76 recorded on the lead-in area 58 respectively is the title, author, or brief introduction of the song recorded on the program data 60. And the length data 74 corresponding to the content data 76 respectively is the length of the title, author, or brief introduction of the song. Certainly, the descriptive data 70 also can comprise other sections according to the complexity of the content data 76.

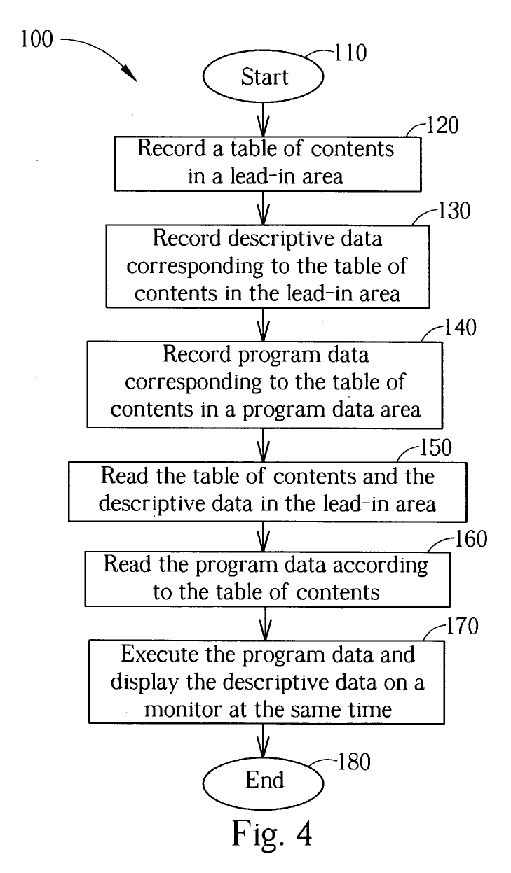

To explain the method of the present invention more specifically, please refer to FIG. 4. FIG. 4 is a flow chart 100 of the method for accessing data on the optical disc 50 with the optical disc drive 40 according to the present invention. The flow chart 100 comprises following steps: Step 110: Start. (At this time, the optical disc 50 has been put on the optical disc drive 40.) Step 120: Use the optical pickup 42 of the optical disc drive 40 to record a table of contents in a lead-in area of a session of the optical disc 50.

Step 130:

Use the optical pickup 42 to record descriptive data corresponding to the table of contents in the rest of the memory space of the lead-in area of the session.

Step 140:

Use the optical pickup 42 to record program data corresponding to the table of contents in a program data area of the session.

Step 150:

Use the optical pickup 42 to read the table of contents and the descriptive data in the lead-in area of the session.

Step 160:

Use the optical pickup 42 to the program data in the program data area of the session according to the table of contents in the lead-in area of the session.

Step 170:

Use the optical disc drive 40 to execute the program data and display the descriptive data on the monitor 44 at the same time.

Step 180:

End. (While the optical disc drive 40 executes the program data, the monitor 44 of the optical disc drive 40 displays content data that describes the program data.)

During step 170, the optical disc drive 40 controls the monitor 44 to display the content data 76 of the descriptive data 70 on the monitor 44 according to the category data 72 of the descriptive data in the lead-in area 58 of the session 56. For instance, when the category data 72 shows that the content data 76 is author of the song (the category data 72 is “10”), the optical disc drive 40 controls the monitor 44 to display the author with large letters until the song is finished playing, and when the category data 72 shows that the content data 76 are words of the song (the category data 72 is “01”), the optical disc drive 40 controls the monitor 44 to display the words with smaller letters as the song is executed and until the song is finished.

As shown in FIG. 3, step 110 to step 140 are processes of using the optical pickup 42 of the optical disc drive 40 to record data to the optical disc 50, and step 150 to step 180 are processes of using the optical pickup 42 of the optical disc drive 40 to read data on the program data area 60 of the lead-in area 58 of the optical disc 50.

Certainly, the optical disc drive 40 used in the present invention also can be used to access an ordinary optical disc, which comprises only a table of contents on the lead-in area of each session.

In contrast to the method for accessing data on the optical disc with the optical disc drive according to the prior art, the present invention uses the rest of the memory space in the lead-in area 58 of the optical disc 50 for recording the descriptive data 70 describing the program data on the program data area 60 of the optical disc 50 so that the memory space of the lead-in area 58 can be fully utilized. Furthermore, the present invention also can display the descriptive data 70 on the monitor 44, while using the optical drive 40 to execute the program data.

Those skilled in the art will readily observe that numerous modifications and alterations of the device may be made while retaining the teachings of the invention. Accordingly, the above disclosure should be construed as limited only by the metes and bounds of the appended claims.

What is claimed is:

1. A method for accessing data on an optical disc with an optical disc drive, wherein the optical disc comprises at least one session, the session comprising a lead-in area and a program data area, the method comprising:
providing the optical disc drive with an optical pickup for accessing the data on the optical disc;
using the optical pickup to record a table of contents in the lead-in area of the session of the optical disc;
using the optical pickup to record descriptive data corresponding to the table of contents in the lead-in area of the session; and
using the optical pickup to record program data corresponding to the table of contents in the program data area of the session.

2. The method of claim 1 wherein the descriptive data comprises a content data for describing the program data on the program data area.

3. The method of claim 2 wherein the descriptive data further comprises a length data for marking a length of the content data.

4. The method of claim 2 wherein the descriptive data further comprises an ending data recorded at the end of the descriptive data for marking an ending position of the descriptive data.

5. The method of claim 2 wherein the descriptive data further comprises a category data for marking a category of the content data.

6. The method of claim 5 wherein the category data is recorded at the beginning of the description data.

7. The method of claim 1 wherein a plurality of sessions of the optical disc are arranged in order.

8. The method of claim 1 wherein the optical disc is a CD-ROM, a VCD, or a DVD.

9. The method of claim 1 wherein the optical disc drive is a CD-ROM drive, a VCD drive, or a DVD drive.

10. The method of claim 1 wherein the session further comprises a lead-out area.

11. The method of claim 1 further comprising:
using the optical pickup to read the table of contents and the descriptive data on the lead-in area of the session;
providing the optical disc drive with a monitor;
using the optical pickup to read the program data on the program data area of the session according to the table of contents on the lead-in area of the session; and
using the optical drive to execute the program data and display the descriptive data on the monitor at the same time.
